(19) United States
(12) Patent Application Publication
(10) Pub. No.: US 2017/0295368 A1
(43) Pub. Date: Oct. 12, 2017

(54) BIT RATE CONTROLLING METHOD AND VIDEO ENCODING DEVICE

(71) Applicant: MStar Semiconductor, Inc., Hsinchu Hsien (TW)

(72) Inventors: Shu-Wei Teng, Hsinchu Hsien (TW); Chia Chiang Ho, Hsinchu Hsien (TW); He-Yuan Lin, Hsinchu Hsien (TW)

(21) Appl. No.: 15/168,307

(22) Filed: May 31, 2016

(30) Foreign Application Priority Data
Apr. 7, 2016 (TW) 105110827

(51) Int. Cl. H04N 19/115; H04N 19/176; H04N 19/172

(52) U.S. Cl. CPC H04N 19/115; H04N 19/172; H04N 19/176

(57) ABSTRACT

A bit rate controlling method applied to a video encoding device includes: establishing a parameter table according to a first frame-level parameter corresponding to a first frame, and storing the parameter table to a look-up table (LUT) unit of the video encoding device; reading the parameter table stored in the LUT unit to obtain at least one encoding parameter corresponding to an encoding block in the first frame according to the parameter table and a target parameter of the encoding block; and encoding the encoding block of the first frame according to the at least one encoding parameter.

This application claims the benefit of Taiwan application Serial No. 105110827, filed Apr. 7, 2016, the subject matter of which is incorporated herein by reference.

### BACKGROUND OF THE INVENTION

### Field of the Invention

The invention relates in general to a bit rate control method and a video encoding device, and more particularly to a bit rate control method and a video encoding device that obtain an encoding parameter corresponding to an encoding block through a look-up table.

### Description of the Related Art

Bit rate control is a fundamental task in video encoding. During video transmission and storage processes, the network bandwidth and storage capacities are limited. The function of bit rate control is to make the outputted video stream satisfy transmission and storage restrictions when performing video encoding for different encoding parameters under the premise that maximized video encoding quality is guaranteed. Thus, bit rate control is critical in applications of video encoding standards.

On the other hand, in known technologies, there are operations that perform video encoding by using software collaborating with a hardware structure (i.e., hardware-software collaborative scheme). In general, software is capable of processing only operations above the frame-level, and encoding operations below the frame-level are performed by hardware. More specifically, an encoding parameter corresponding to a frame is calculated according to different models through software, and hardware may then encode a plurality of encoding blocks of the frame according to the frame-level parameter calculated by the software. It should be noted that, even when the plurality of encoding blocks may have different target bits per pixel (Bpp), the hardware still encodes the plurality of encoding blocks of the frame according to the frame-level parameter calculated by the software. That is, all of the encoding blocks of the frame are applied with the same encoding parameter (i.e., the frame-level parameter calculated by the software) for video encoding, in a way that the video encoding of the frame may not be adequately precise, hence rendering an unsatisfactory bit rate control effect. Further, the conventional encoding parameter is calculated and obtained according to different models through software that involves a higher calculation complexity level. Therefore, there is a need for a solution for improving such known technologies.

### SUMMARY OF THE INVENTION

It is a primary object of the present invention to provide a bit rate control method and a video encoding device for improving issues of known technologies.

The present invention discloses a bit rate control method applied to a video encoding device. The bit rate control method includes: establishing a parameter table according to a first frame-level parameter corresponding to a first frame, and storing the parameter table to a look-up table (LUT) unit of the video encoding device; reading the parameter table stored in the LUT unit to obtain at least one encoding parameter corresponding to an encoding block in the first frame according to the parameter table and a target parameter of the encoding block; and encoding the encoding block of the first frame according to the at least one encoding parameter.

The present invention further discloses a video encoding device including: a look-up table (LUT) unit, storing a parameter table and providing at least one encoding parameter corresponding to an encoding block in a first frame according to the parameter table and a target parameter of the encoding block; a processing unit; a storage unit, storing a program code that instructs the processing unit to perform steps of establishing a parameter table according to a first frame-level parameter corresponding to the first frame and storing the parameter table to the LUT unit of the video encoding device; and an encoding unit, encoding the encoding block of the first frame according to the target parameter and the at least one encoding parameter.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a video encoding device according to an embodiment of the present invention;

FIG. 2 is a schematic diagram of a frame;

FIG. 3 is a schematic diagram of a bit rate control process according to an embodiment of the present invention; and

FIG. 4 is a schematic diagram of a process of establishing a parameter table according to an embodiment of the present invention.

### DETAILED DESCRIPTION OF THE INVENTION

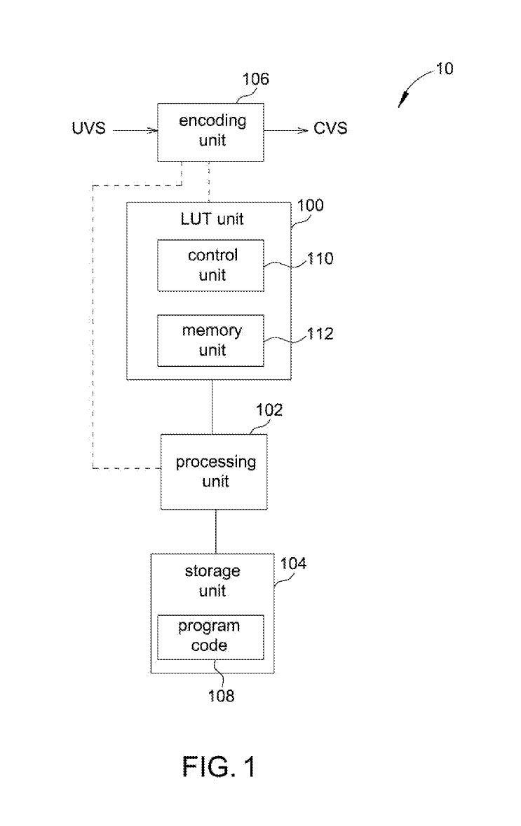

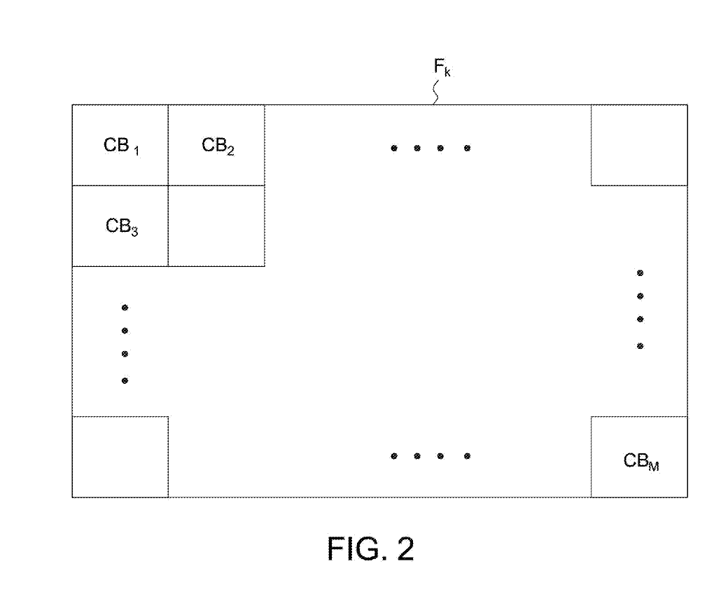

FIG. 1 shows a schematic diagram of a video encoding device 10 according to an embodiment of the present invention. FIG. 2 shows a schematic diagram of a frame Fₖ and encoding blocks CB₁ to CB_{M} therein. Referring to FIG. 1 and FIG. 2, the video encoding device 10 receives a video data stream UVS and performs video encoding on the video data stream UVS to generate a compressed video data stream CVS. The video data stream UVS includes frames F₁ to F_{K}. Further, the video encoding device 10 performs video encoding on the encoding blocks CB₁ to CB_{M} included in each frame Fₖ of the frames F₁ to F_{K}. The encoding block may represent a macro block, a coding tree unit (CTU) or basic encoding units in other frames. Further, the video encoding device 10 may obtain encoding parameters respectively corresponding to the encoding blocks CB₁ to CB_{M}, and perform video encoding on the encoding blocks CB₁ to CB_{M}. The encoding parameter may be a Lagrange multiplier (λ), a quantization parameter (Qp) or bits per pixel (bpp).

The video encoding device 10 includes a look-up table (LUT) unit 100, a processing unit 102, a storage unit 104 and an encoding unit 106. The LUT unit 100 may include a control unit 110 and a memory unit 112. The storage unit 104 stores a program code 108, which instructs the processing unit 102 to establish a parameter table according to a first frame-level parameter corresponding to the frame Fₖ, and to store the parameter table in a memory unit 112 of the LUT unit 100. When the encoding unit 106 performs video encoding on the encoding blocks CB₁ to CB_{M}, the control unit 110 may read from the memory unit 112 and output the encoding parameters corresponding the encoding blocks CB₁ to CB_{M}, and transmit the encoding parameters corresponding to the encoding blocks CB₁ to CB_{M} to the encoding unit 106. The encoding unit 106 may perform video encoding on the encoding blocks CB₁ to CB_{M} according to the encoding parameters corresponding to the encoding blocks CB₁ to CB_{M}. More specifically, the processing unit 102 or the control unit 110 of the LUT unit 100 may access the memory unit 112 according to a target parameter (e.g., target bits per pixel (bpp)) to obtain the encoding parameter (e.g., a Lagrange multiplier, a quantization parameter or bits per pixel) of the encoding block. As such, the encoding unit 106 performs video encoding on the encoding block according to the encoding parameter of the encoding block. The processing unit 102 may be a general purpose processor, and may be, for example but not limited to, a central processor (CPU) or a microprocessor. The storage unit 104 may be a read-only memory (ROM) or a non-volatile memory, for example but not limited to, an electrically erasable programmable read only memory (EEPROM) or a flash memory. Further, for example but not limited to, the LUT unit 100 and the encoding unit 106 may be application-specific integrated circuits (ASIC). The memory unit 112 of the LUT unit 100 stores the parameter table established by the processing unit 102, and may be, for example, a static random access memory (SRAM) or a register. The control unit 110 of the LUT unit 100 reads and outputs the encoding parameters corresponding to the CB₁ to CB_{M} to the encoding unit 106. For example, the control unit 110 may be an application-specific logic control circuit or an application-specific processor.

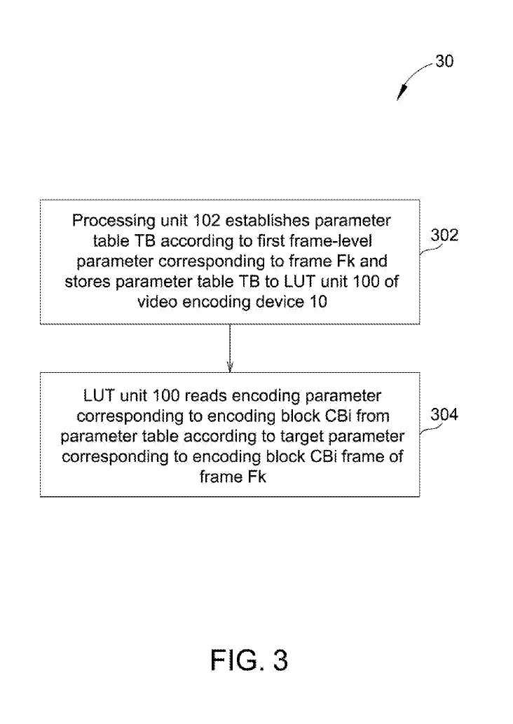

Operations of the video encoding device 10 may be concluded to a bit rate control process 30, as FIG. 3 showing a schematic diagram of the bit rate control process 30 according to an embodiment of the present invention. The bit rate control process 30 is performed by the video encoding device 10, and includes following steps.

In step 302, a parameter table TB is established according to a first frame-level parameter corresponding to a frame Fₖ, and the parameter table TB is stored in the LUT unit 100 of the video encoding device 10.

In step 304, an encoding parameter corresponding to an encoding block CBᵢ in the frame Fₖ is read from the parameter table TB according to a target parameter of the encoding block CBᵢ.

After the video encoding device 10 performs the bit rate control process 30 and the encoding parameter of the encoding block CBᵢ is obtained, the encoding parameter of the encoding block CBᵢ may be transmitted to the encoding unit 106, which then encodes the encoding block CBᵢ. Based on the bit rate control process 30, the video encoding device 10 may obtain the encoding parameter corresponding to the encoding block CBᵢ according to the first frame-level parameter of the frame Fₖ. Operation details of the bit rate control process 30 are given below.

In step 302, the video encoding device 10 establishes the parameter table TB according to the first frame-level parameter corresponding to the frame Fₖ, and stores the parameter table TB in the memory unit 112 of the LUT unit 100. Step 302 may be coded into a program code 108 that is executed by the processing unit 102. More specifically, the processing unit 102 may first calculate a plurality of first encoding parameters according to the first frame-level parameter corresponding to the frame Fₖ, calculate a plurality of second encoding parameters according to the plurality of first encoding parameters, and arrange the first encoding parameters and the second encoding parameters in a monotonic (i.e., increasing or decreasing) manner in the parameter table TB.

More specifically, in one embodiment, the processing unit 102 may obtain a Lagrange multiplier λ₀ (the first frame-level parameter) corresponding to the frame Fₖ from the video encoding device 10, and calculate a plurality of Lagrange multipliers λ_{-N} to λ₋₁ and λ₁ to λ_{N} (the plurality of first encoding parameters) according to the Lagrange multiplier λ₀. The Lagrange multipliers λ_{-N} to λ_{N} are monotonic; that is, the Lagrange multipliers λ_{-N} to λ₋₁ and λ₁ to λ_{N} are arranged in an increasing order (i.e., λ_{N}>λ_{N-1}) or are arranged in a decreasing order (i.e., λ_{N}<λ_{N-1}). The method that the processing unit 102 uses to calculate the λ_{-N} to λ₋₁ and λ₁ to λ_{N} according to the Lagrange multiplier λ₀ is not limited. For example, the processing unit 102 may multiply the Lagrange multiplier λ₀ by a plurality of magnifications r_{-N} to r₋₁ and r₁ to r_{N} to calculate the plurality of Lagrange multipliers λ_{-N} to λ₋₁ and λ₁ to λ_{N} (i.e., λₙ=rₙλ₀). Wherein, the plurality of magnifications r_{-N} to r₋₁ and r₁ to r_{N} represent magnifications between the plurality of Lagrange multipliers λ_{-N} to λ₋₁ and λ₁ to λ_{N} and the Lagrange multiplier λ₀.

After obtaining the plurality of Lagrange multipliers λ_{-N} to λ_{N}, the processor 102 may calculate quantization parameters Qp_{-N} to Qp_{N} (a quantization Qp₀ may represent a second frame-level parameter, and quantization parameters Qp_{-N} to Qp₋₁ and Qp₁ to Qp_{N} may represent a plurality of second encoding parameters) respectively corresponding to the Lagrange multipliers λ_{-N} to λ_{N} through a function operation according to the Lagrange multipliers λ_{-N} to λ_{N}. For example, the processing unit 102 may calculate the quantization parameters Qp_{-N} to Qp_{N} through a function f1(•), i.e., calculating Qpₙ−f₁(λ_{N}). Wherein, f1(•) may be a monotonic function, and represents the corresponding function between the Lagrange multiplier and the quantization parameter. In one embodiment, the function f1(•) may be correlated to a logarithmic function, and the processing unit 102 may calculate the quantization parameter as Qpₙ=f₁(λₙ)=c₁ ln(λₙ)+c₂, where ln(•) represents a logarithmic function, and c₁ and c₂ are constants that may be adjusted according to actual conditions. As the Lagrange multipliers λ_{-N} to λ_{N} are monotonic and the logarithmic function f₁(•) is a monotonic function, the quantization parameters Qp_{-N} to Qp_{N} are also monotonic.

Further, the processing unit 102 may calculate bits per pixel Bpp_{-N} to Bpp_{N} respectively corresponding to the Lagrange multipliers λ_{-N} to λ_{N} through another function operation (at this point, the bits per pixel Bpp₀ represents the second frame-level parameter, and the bits per pixels Bpp_{-N} to Bpp₋₁ and Bpp₁ to Bpp_{N} represent a plurality of encoding parameters), wherein the bits per pixel Bpp₀ corresponds to the Lagrange multiplier λ₀ (i.e., the first frame-level parameter). For example, the processing unit 102 may calculate the bits per pixel Bppₙ through a function f₂(•), i.e., the bits per pixel is Bppₙ=f₂(λₙ), where f₂(•) is a monotonic function and represents a logarithmic function between the Lagrange multiplier and the bits per pixel. In one embodiment, the processing unit 102 may calculate the bits per pixel as Bppₙ=f₂(λₙ)=α(λₙ)^{β}, where α and β are constants that may be adjusted according actual conditions. As the Lagrange multipliers λ_{-N} to λ_{N} are monotonic and the logarithmic function f₂(•) is a monotonic function, the quantization parameters Bpp_{-N} to Bpp_{N} are also monotonic.

On the other hand, the Lagrange multipliers λ_{-N} to λ_{N}, the quantization parameters Qp_{-N} to Qp_{N} and the bits per pixel Bpp_{-N} to Bpp_{N} are arranged in an increasing (or decreasing) order in the parameter table TB. Referring to Table-1 showing an example of the parameter table TB, the parameter table TB includes an index row, a Lagrange multiplier row, a quantization parameter row and a bits per pixel row. The Lagrange multipliers λ_{-N} to λ_{N}, the quantization parameters Qp_{-N} to Qp_{N} and the bits per pixel Bpp_{-N} to Bpp_{N} are arranged in an increasing (or decreasing) order in the Lagrange multiplier row, the quantization parameter row and the bits pixel row, respectively. The central row entries in the Lagrange multiplier row, the quantization parameter row and the bits pixel row are respectively row entries corresponding to the index 0, and are the Lagrange multiplier λ₀, the quantization parameter Qp₀ and the bits per pixel Bpp₀, respectively.

TABLE 1

| Index | −N | . . . | −1 | 0 | 1 | . . . | N |
|---|---|---|---|---|---|---|---|
| Lagrange | λ_{-N} | . . . | λ₋₁ | λ₀ | λ₁ | . . . | λ_{N} |
| multiplier | | | | | | | |
| Quantization | Qp_{-N} | . . . | Qp₋₁ | Qp₀ | Qp₁ | . . . | Qp_{N} |
| parameter | | | | | | | |
| Bits per pixel | Bpp_{-N} | . . . | Bpp₋₁ | Bpp₀ | Bpp₁ | . . . | Bpp_{N} |

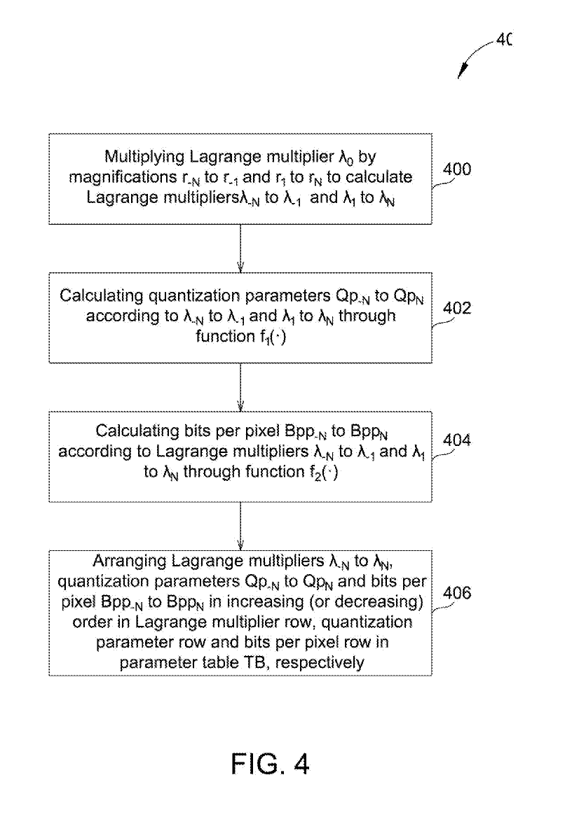

Operation details of the processing unit 102 establishing the parameter table TB according to the Lagrange multiplier λ₀ corresponding to the frame Fₖ may be further concluded into a parameter establishing process 40 as shown in FIG. 4. The parameter establishing process 40 includes following steps.

In step 400, the Lagrange multiplier λ₀ is multiplied by the magnifications r_{-N} to r₋₁ and r₁ to r_{N} to calculate the Lagrange multipliers λ_{-N} to λ₋₁ and λ₁ to λ_{N}.

In step 402, the quantization parameters Qp_{-N} to Qp_{N} are calculated through the function f1(•) according to the Lagrange multipliers λ_{-N} to λ₋₁ and λ₁ to λ_{N}.

In step 404, the bits per pixel Bpp_{-N} to Bpp_{N} are calculated through the function f2(•) according to the Lagrange multipliers λ_{-N} to λ₋₁ and λ₁ to λ_{N}.

In step 406, the Lagrange multipliers λ_{-N} to λ_{N}, the quantization parameters Qp_{-N} to Qp_{N} and the bits per pixel Bpp_{-N} to Bpp_{N} are arranged in an increasing (or decreasing) order in the Lagrange multiplier row, the quantization parameter row and the bits pixel row of the parameter table TB, respectively.

Other operation details of the parameter establishing process 40 may be referred from the foregoing associated description, and shall be omitted herein. In step 304, the video encoding device 10 reads the parameter table TB stored in the LUT unit 100, and obtains the encoding parameter corresponding to the encoding block CBᵢ in the frame Fₖ from the parameter table TB in the memory unit 112 according to a target parameter of the encoding block CBᵢ. Step 304 may be coded into a program code 108 that is executed by the processing unit 102, or may be directly executed by the control unit 110 of the LUT unit 100. More specifically, the video encoding device 10 may read the Lagrange multiplier, the quantization parameter and the bits per pixel corresponding to the encoding block CBᵢ from the parameter table TB stored in the memory unit 112 according to a target bits per pixel TBppᵢ of the encoding block CBᵢ. The method that the video encoding device 10 uses to read the encoding parameter corresponding to the encoding block CBᵢ according to target bits per pixel TBppᵢ from the parameter table TB is not limited. For example, the video encoding device 10 may compare the target bits per pixel TBppᵢ with the bits per pixel Bpp_{-N} to Bpp_{N} to obtain the bits per pixel Bppⱼ, which is the bits per pixel closest to the target bits per pixel TBppᵢ among the bits per pixel Bpp_{-N} to Bpp_{N}. That is, the video encoding device 10 obtains the index j. In other words, the difference between the target bits per pixel TBppᵢ and the bits per pixel Bppⱼ is the smallest (compared to other differences between the remaining target bits per pixel and the target bits per pixel TBppᵢ). After the video encoding device 10 obtains the index j, the column entry corresponding to the index j may be read from the parameter table TB to further obtain the Lagrange multiplier λⱼ, the quantization parameter Qpⱼ and the bits per pixel Bppⱼ as the encoding parameters corresponding to the encoding block CBᵢ.

It should be noted that, the video encoding device 10 is not limited to reading the encoding parameter from the parameter table TB according to the target bits per pixel. Alternatively, the video encoding device 10 may also read the encoding parameter from the parameter table TB stored in the memory unit 112 according to a sum of absolute transformed difference (SATD) or a mean absolute deviation (MAD). Operation details of reading the encoding parameter from the parameter table according to the SATD or MAD are generally known to one person skilled in the art, and shall be omitted herein.

After the processing unit 102 or the control unit 110 of the LUT unit 100 obtains the Lagrange multiplier λⱼ, the quantization parameter Qpⱼ and the bits per pixel Bppⱼ, the Lagrange multiplier λⱼ, the quantization parameter Qpⱼ and the bits per pixel Bppⱼ are transmitted to the encoding unit 106, and the encoding block CBᵢ is then encoded by the encoding unit 106. It should be noted that, although the encoding block CBᵢ in the frame Fₖ is given as an example in the foregoing processes, the video encoding device 10 may also use the same operation processes to encode the remaining encoding blocks of the encoding blocks CB₁ to CB_{M}. As such, the video encoding device 10 may obtain the encoding parameters corresponding to the encoding blocks CB₁ to CB_{M} and accordingly encode the encoding blocks CB₁ to CB_{M} based on the target bits per pixel TBpp₁ to TBpp_{M} of the encoding blocks CB₁ to CB_{M} to achieve an optimal bit rate control effect.

The processing unit 102 or the control unit 110 may calculate an average value λₐᵥₑ of the Lagrange multipliers λ_{-N} to λ_{N} and an average value Qpₐᵥₑ of the quantization parameters Qp_{-N} to Qp_{N}. When the video encoding device 10 is to perform video encoding of the next frame Fₖ₊₁ of the frame Fₖ, the average value λₐᵥₑ and the average value Qpₐᵥₑ may be regarded as frame-level parameters corresponding to the frame Fₖ₊₁. That is, the video encoding device 10 may perform the foregoing processes according to the frame-level parameters (the average value λₐᵥₑ and the average value Qpₐᵥₑ) of the frame Fₖ₊₁ to encode the frame Fₖ₊₁. In other words, the average value λₐᵥₑ is the average value of all of the row entries in the Lagrange multiplier row in the parameter table TB, and the average value Qpₐᵥₑ is the average value of all of the row entries in the quantization parameter row. Preferably, the average value λₐᵥₑ is a geometric mean of all of the row entries of the Lagrange multiplier row, and the average value Qpₐᵥₑ is an arithmetic mean of the all of the row entries of the quantization parameter row.

It is known from the above that, the video encoding device of the present invention establishes a parameter table according to a first frame-level parameter, and obtains an encoding parameter through a look-up table. Compared to a conventional video encoding device that obtains an encoding parameter through a software model and calculation, the video encoding device of the present invention has a lower calculation complexity level.

It should be noted that, the foregoing non-limiting embodiments are for illustrating concepts of the present invention, and one person skilled in the art may make different modifications without departing from the spirit of the present invention. For example, in step 302, the processing unit 102 first calculates the Lagrange multipliers λ_{-N} to λ_{N}, and then calculates the quantization parameters Qp_{-N} to Qp_{N} and the bits per pixel Bpp_{-N} to Bpp_{N} according to the Lagrange multipliers λ_{-N} to λ_{N}. Alternatively, the processing unit 102 may first calculate the quantization parameters Qp_{-N} to Qp_{N} according to the Lagrange multipliers λ_{-N} to λ_{N}, and then calculate the bits per pixel Bpp_{-N} to Bpp_{N} according to the quantization parameters Qp_{-N} to Qp_{N}. Alternatively, the processing unit 102 may first calculate the bits per pixel Bpp_{-N} to Bpp_{N} according to the Lagrange multipliers λ_{-N} to λ_{N}, and then calculate the quantization parameters Qp_{-N} to Qp_{N} according to the bits per pixel Bpp_{-N} to Bpp_{N}. Such modifications are also encompassed within the scope of the present invention.

Further, in step 304, the video encoding device 10 compares the target bits per pixel TBppᵢ of the encoding block CBᵢ with the bits per pixel Bpp_{-N} to Bpp_{N} in the parameter table TB to obtain the bits per pixel Bppⱼ as the bits per pixel that is closest to the target bits per pixel TBppᵢ. However, the present invention is not limited to the above example. Alternatively, the video encoding device 10 may also obtain the bits per pixel Bppⱼ and Bppⱼ₊₁ closest to the target bits per pixel TBppᵢ and the indices j and j+1 from the bits per pixel Bpp_{-N} to Bpp_{N} in the parameter table TB, read the Lagrange multipliers λⱼ and λⱼ₊₁ and the quantization parameters Qpⱼ and Qpⱼ₊₁ from the parameter table TB according to the indices j and j+1, and calculate a Lagrange multiplier λⱼ′, a quantization parameter Qpⱼ′ and a bits per pixel Bppⱼ′ according to the Lagrange multipliers λⱼ and λⱼ₊₁, the quantization parameters Qpⱼ and Qpⱼ₊₁ and the bits per pixel Bppⱼ and Bppⱼ₊₁ by any interpolation means. The encoding unit 106 may then encode the encoding block CBᵢ according to the Lagrange multiplier λⱼ′, the quantization parameter Qpⱼ′ and the bits per pixel Bppⱼ′. The Lagrange multiplier λⱼ′ is an interpolation result of the Lagrange multipliers λⱼ and λⱼ₊₁, the quantization parameter Qpⱼ′ is an interpolation result of quantization parameters Qpⱼ and Qpⱼ₊₁, and the bits per pixel Bppⱼ′ is an interpolation result of the bits per pixel Bppⱼ and Bppⱼ₊₁.

It is demonstrated by the foregoing description that, in the present invention, a parameter table is established and stored in an LUT unit. When performing video encoding, the video encoding device may read the parameter table, and obtain encoding parameters of a plurality of encoding blocks in the same frame. Compared to known technologies, the present invention achieves a better bit rate control effect and a lower calculation complexity level.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A bit rate control method, applied to a video encoding device, the bit rate control method comprising:
establishing a parameter table according to a first frame-level parameter corresponding to a first frame, and storing the parameter table to a look-up table (LUT) unit of the video encoding device;
reading at least one encoding parameter corresponding to an encoding block of the first frame from the parameter table according to a target parameter of the encoding block; and
encoding the encoding block of the first frame according to the at least one encoding parameter.

2. The bit rate control method according to claim 1, wherein the step of establishing the parameter table according to the first frame-level parameter comprises:
calculating a plurality of first encoding parameters according to the first frame-level parameter; and
calculating a plurality of second encoding parameters according to the plurality of first encoding parameters;
wherein, the parameter table comprises the plurality of first encoding parameters and the plurality of second encoding parameters.

3. The bit rate control method according to claim 2, wherein the step of calculating the plurality of first encoding parameters according to the first frame-level parameter comprises:
multiplying the first frame-level parameter by a plurality of magnifications to calculate the plurality of first encoding parameters.

4. The bit rate control method according to claim 2, wherein the step of calculating the plurality of second encoding parameters according to the plurality of first encoding parameters comprises:
performing a function operation, an input value of the function being the plurality of first encoding parameters, to
obtain the plurality of second encoding parameters;
wherein, the function is a monotonically increasing function or a monotonically decreasing function.

5. The bit rate control method according to claim 2, wherein the step of establishing the parameter table according to the first frame-level parameter comprises:
arranging the plurality of first encoding parameters in an increasing or decreasing order in a first row of the parameter table; and
arranging the plurality of second encoding parameters in an increasing or decreasing order in a second row of the parameter table;
wherein, a central row entry of the first row is the first frame-level parameter, and a central row entry of the second row is the second frame-level parameter.

6. The bit rate control method according to claim 2, wherein the step of establishing the parameter table according to the first frame-level parameter comprises:
calculating a plurality of third encoding parameters according to the plurality of second encoding parameters;
wherein, the parameter table further comprises the plurality of third encoding parameters.

7. The bit rate control method according to claim 1, wherein the step of reading the at least one encoding parameter corresponding to the encoding block of the first frame from the parameter table according to the target parameter of the encoding block comprises:
obtaining an index corresponding to the target parameter according to the parameter table and the target parameter; and
obtaining the at least one encoding parameter corresponding to the encoding block as at least one column entry corresponding to the index in the parameter table according to the parameter table and the index.

8. The bit rate control method according to claim 7, wherein the step of reading the index corresponding to the target parameter according to the target parameter comprises:
comparing the target parameter with a plurality of row entries of a row of the parameter table;
selecting a first row entry from the plurality of row entries, wherein between the target parameter and the first row entry is a smallest difference; and
obtaining the index corresponding to the target parameter as a first index corresponding to the first row entry.

9. The bit rate control method according to claim 1, further comprising:
calculating a first average value of a plurality of first row entries located at a first row of the parameter table according to the plurality of the first row entries;
obtaining a third frame-level parameter corresponding to a second frame as the first average value;
calculating a second average value of a plurality of second row entries located at a second row of the parameter table according to the plurality of second row entries; and
obtaining a fourth frame level-parameter corresponding to the second frame as the second average value;
wherein, the first average value is a geometric mean of the plurality of first row entries, and the second average value is an arithmetic mean of the plurality of second row entries.

10. The bit rate control method according to claim 1, wherein the step of obtaining the at least one encoding parameter corresponding to the encoding block according to the parameter table and the target parameter comprises:
comparing the target parameter with a plurality of row entries of a row of the parameter table;
selecting a first row entry and a second row entry from the plurality of row entries, wherein between the target parameter and the first row entry, and the target parameter and the second row entry, are a smallest difference and a second smallest difference, respectively;
obtaining a first index corresponding to the first row entry and a second index corresponding the second row entry;
obtaining at least one first row entry and at least one second row entry corresponding to the first index and the second index from the parameter table according to the first index and the second index, respectively; and
performing interpolation on the at least one first row entry and the at least one second row entry to calculate at least one interpolation result as the at least one encoding parameter corresponding to the encoding block.

11. A video encoding device, comprising:
a processing unit;
a storage unit, storing a program code, the program code instructing the processing unit to establish a parameter table according to a first frame-level parameter corresponding to a first frame;
a look-up table (LUT) unit, storing the parameter table, wherein the LUT unit provides at least one encoding parameter corresponding to the encoding block from the parameter table according to a target parameter of an encoding block of the first frame; and
an encoding unit, encoding the encoding block of the first frame according to the target parameter and the at least one encoding parameter.

12. The video encoding device of claim 11, wherein the program code further instructs the processing unit to perform following steps to establish the parameter table according to the first frame-level parameter:
calculating a plurality of first encoding parameters according to the first frame-level parameter; and
calculating a plurality of second encoding parameters according to the plurality of first encoding parameters;
wherein, the parameter table comprises the plurality of first encoding parameters and the plurality of second encoding parameters.

13. The video encoding device of claim 12, wherein the program code further instructs the processing unit to perform a following step to calculate the plurality of first encoding parameters according to the first frame-level parameter:
multiplying the first frame-level by a plurality of magnifications to calculate the plurality of first encoding parameters.

14. The video encoding device of claim 12, wherein the program code further instructs the processing unit to perform following steps to calculate the plurality of second encoding parameters according to the plurality of first encoding parameters:
performing a function operation, an input value of the function being the plurality of first encoding parameters, to obtain the plurality of second encoding parameters;
wherein, the function is a monotonically increasing function or a monotonically decreasing function.

15. The video encoding device of claim 12, wherein the program code further instructs the processing unit to perform following steps to establish the parameter table according to the first frame-level parameter:
arranging the plurality of first encoding parameters in an increasing or decreasing order in a first row of the parameter table; and
arranging the plurality of second encoding parameters in an increasing or decreasing order in a second row of the parameter table;
wherein, a central row entry of the first row is the first frame-level parameter, and a central row entry of the second row is the second frame-level parameter.

16. The video encoding device of claim 12, wherein the program code further instructs the processing unit to perform a following step to establish the parameter table according to the first frame-level parameter:
calculating a plurality of third encoding parameters according to the plurality of second encoding parameters;
wherein, the parameter table further comprises the plurality of third encoding parameters.

17. The video encoding device of claim 11, wherein the LUT unit or the processing unit further performs following steps to read the at least one encoding parameter corresponding to the encoding block from the parameter table according to the target parameter:
obtaining an index corresponding to the target parameter according to the parameter table and the target parameter; and
obtaining the at least one encoding parameter corresponding to the encoding block as at least one column entry corresponding to the index from the parameter table according to the parameter table and the index.

18. The video encoding device of claim 17, wherein the wherein the LUT unit or the processing unit further performs following steps to read the index corresponding to the target parameter according to the target parameter:
comparing the target parameter with a plurality of row entries of a row of the parameter table;
selecting a first row entry from the plurality of row entries, wherein between the target parameter and the first row entry is a smallest difference; and
obtaining the index corresponding to the target parameter as a first index corresponding to the first row entry.

19. The video encoding device of claim 11, wherein the LUT unit or the processing unit further performs steps of:
calculating a first average value of a plurality of first row entries located at a first row of the parameter table according to the plurality of the first row entries;
obtaining a third frame-level parameter corresponding to a second frame as the first average value;
calculating a second average value of a plurality of second row entries located at a second row of the parameter table according to the plurality of second row entries; and
obtaining a fourth frame level-parameter corresponding to the second frame as the second average value;
wherein, the first average value is a geometric mean of the plurality of first row entries, and the second average value is an arithmetic mean of the plurality of second row entries.

20. The video encoding device of claim 11, wherein the LUT unit or the processing unit further performs following steps to obtain the at least one encoding parameter corresponding to the encoding block according to the parameter table and the target parameter:
comparing the target parameter with a plurality of row entries of a row of the parameter table;
selecting a first row entry and a second row entry from the plurality of row entries, wherein between the target parameter and the first row entry, and the target parameter and the second row entry, are a smallest difference and a second smallest difference, respectively;
obtaining a first index corresponding to the first row entry and a second index corresponding the second row entry;
obtaining at least one first row entry and at least one second row entry corresponding to the first index and the second index from the parameter table according to the first index and the second index, respectively; and
performing interpolation on the at least one first row entry and the at least one second row entry to calculate at least one interpolation result as the at least one encoding parameter corresponding to the encoding block.
